(19) United States
(12) Patent Application Publication
(10) Pub. No.: US 2010/0082227 A1
(43) Pub. Date: Apr. 1, 2010

(54) METHOD FOR DISPLAYING TRAFFIC DENSITY INFORMATION

(75) Inventors: Stefan Posner, Munchen (DE); Alexey Pryakhin, Munchen (DE); Peter Kunath, Munchen (DE); Michael Vagner, Munchen (DE)

Correspondence Address: THE ECLIPSE GROUP LLP, 10605 BALBOA BLVD., SUITE 300, GRANADA HILLS, CA, 91344, US

(73) Assignee: Harman Becker Automotive Systems GmbH, Karlsbad (DE)

(21) Appl. No.: 12/561,031

(22) Filed: Sep. 16, 2009

(30) Foreign Application Priority Data
Sep. 17, 2008 (EP) EP 08 016 374.4

(51) Int. Cl. G01C 21/36; G08G 1/0968

(52) U.S. Cl. 701/118

(57) ABSTRACT

The present invention relates to displaying traffic density information, from historical traffic density information after determining for which moment in time the traffic density information should be displayed and displaying the traffic density information on a display.

### RELATED APPLICATIONS

This application claims priority of European Application Serial Number 08 016 374.4, filed on Sep. 17, 2008, titled METHOD FOR DISPLAYING TRAFFIC DENSITY INFORMATION, which application is incorporated in its entirety by reference in this application.

### BACKGROUND OF THE INVENTION

1. Field of the Invention

This invention relates to displaying traffic density information in a navigation system, but is limited to only vehicle-based navigation systems that are used for calculating a route to a predetermined destination.

2. Related Art

In the art navigation systems, navigation approaches are known which are able to calculate a route to a predetermined destination. These navigation approaches are able to consider current traffic density information received via a cell phone, a broadcast radio signal, or another type of wired or wireless connection. Possible technologies for receiving traffic information include TMC (Traffic Message Channel), VICS (Vehicle Information and Communication System), or TPEG (Transport Protocol Experts Group). These technologies provide traffic information to drivers, the traffic information being digitally coded on either conventional FM radio broadcasts or another transmission channel. When the navigation system is coupled to the received traffic information signal, the navigation system may avoid traffic congestions by calculating a route around the congestion.

In many urban areas, it noted that for a certain part of the day the same routes are congested. However, a person who is not familiar with the traffic patterns in a certain geographical area may not be aware of the common traffic situation. It might be beneficial to know the locations at which under normal circumstances difficult traffic situations can occur at predetermined days or predetermined times of a day.

Accordingly, a need exists to provide a driver with the knowledge about typical driving patterns that may exist in a certain geographical area at a certain point of time.

### SUMMARY

An approach for displaying traffic density information is described that provides historical traffic density information. When the moment in time is known for which traffic density information is needed, the traffic density information may be determined for a moment in time and displayed on a display. The user, to which the traffic density information for the certain moment in time is displayed, may then use the provided information to determine a route to a predetermined destination, a time for starting the route, etc. By way of example if the user to which the traffic density information is provided is able to select the starting time for travel, the user may, based on the displayed traffic density information, decide the optimum time at which to should start traveling. The historical traffic density information may provide an aggregated traffic pattern over time. The aggregated traffic pattern might be obtained by collecting traffic messages over a longer period of time.

Furthermore, it is possible to collect traffic density information over time and to display the traffic density information in a chronological order to the user upon request. In this implementation, the user may study the traffic pattern over time and then decide how to react and when to start the trip or which route to take. By way of example the traffic density information may be displayed by displaying a map where the locations with difficult traffic are highlighted, either by using colors or by using traffic signs indicating that traffic congestion is expected in that part of the route. The historical traffic density information may be obtained by collecting traffic information contained in a broadcast radio signal, such as the TMC signal component. Moreover, it may also be possible that the historical traffic density information is obtained from other vehicles or from the vehicle itself.

Furthermore, it is possible to collect the current traffic density information and to combine it with the historical traffic density information. In order to clean the data and avoid erroneous input, this combination may be supported by an outlier detection module which filters traffic density information that is unreliable and merges only reliable traffic information with the historical existing density information. The outlier detection module may be carried out in order to determine whether the current traffic density information, such as congestion at a certain part of the route at a certain time of the day, is a singular event or whether the current traffic situation fits to the historical traffic density information. This means that it is possible to determine whether the current traffic density information is in agreement with the knowledge obtained from the historical traffic density information. By way of example, it has to be determined whether traffic congestion for a certain part of the route occurs frequently. Furthermore, the outlier detection module may include a step of adapting the historical traffic density information in view of the current traffic density information. This implies that the corresponding traveling times along a road segment may be increased, when the message is received that the traffic congestion is expected for a certain part of the route. By way of example it may be necessary to increase the corresponding traveling time along a certain road segment in view of the received traffic information. The more often the same traffic information is received for a certain road segment, the more the corresponding travel time along said road segment will have to be increased, and the higher the probability that a difficult traffic situation will occur in that road segment.

According to another embodiment it is furthermore possible that a future traffic density is predicted based on the historical traffic density information. By way of example, a user may be interested in the traffic situation in the next two hours for a certain geographical region or for a certain route. Based on the historical traffic density information, i.e. the existing traffic patterns, the traffic density can be predicted for the future. The predicted traffic density can then be used for determining a route to a predetermined destination and/or can be displayed to the user. Based on the provided information the user can then decide how to react and how to select a route or a travel starting time. Additionally, the predicted future traffic density can then be compared to the actual occurring traffic density at the predicted moment of time. Based on comparison it might be necessary to adapt the future prediction of the traffic situation or to adapt the historical traffic density information that formed the basis for the prediction.

The future traffic density might be predicted using a Markov chain, the Markov chain being a stochastic process which is based on the fact that future states will be reached through a probabilistic process. The system described by a Markov chain may change its state at each step or remain in the same state according to a certain probability. In the present example the vertices of map data correspond to the states and the edges of the map data correspond to the transitions. With a given traffic situation or with a historical traffic density information it is possible to predict the traffic density using the Markov chain. The historical traffic data are used in order to estimate the density on each edge or road segment.

Other ways to predict future traffic density include a classification process, a statistical regression analysis, or a graphical model. In case of the classification process, the historical traffic density information is used to train the classifier for different regions of the map and different points of time. When new traffic information is observed, this traffic information may be used to predict the future state of the traffic situation. In addition, the new traffic information may also be used to further train the classifier module.

Additionally, it is possible to provide a confidence level for the historical traffic density information and for the predicted future density. For the historical traffic density information the confidence value may indicate a certainty for traffic congestion or any other difficult traffic situation will occur in a certain route segment. For predicting future traffic density the confidence level may indicate the reliability of the predicted information. For the calculation of a route to a predetermined destination the confidence levels may be taken into account. This confidence level may reflect whether a difficult traffic situation will be expected for a certain part of the road with high probability.

According to a further aspect of the invention, an approach for displaying traffic density information is provided; the approach may have a database containing the historical traffic density information. Depending on time, a traffic density determination module is provided determining the traffic density information for a predetermined moment in time, a display displaying the traffic density information. The traffic density determination unit may comprise a prediction module (predictor) trained or parameterized with the collected historical traffic density information. Furthermore, currently received traffic density information may be used by the predictor in order to predict future traffic density based on the historical and the current traffic density information. The predictor is configured in such a way that, based on traffic density information at time t, traffic density information for t +Δt is calculated. The predictor may be used to calculate a future traffic density; however, the predictor may also be enriched by traffic situations which are known for some points in time during the upcoming time interval to provide more precise traffic density information over a longer time interval (e.g. several hours). Thus, the predictor needs not necessarily predict the traffic situation in the future, seen from the moment when the system is used. The predictor also may calculate traffic density information for the past by calculating traffic density information for a period of time in the past based on traffic density information provided for discrete points in time in said period of time. The approach may furthermore comprise a route determination module that determines a route to a predetermined destination on the basis of the historical traffic density information and/or on the basis of the predicted traffic density. Furthermore, the approach may comprise a control element which is designed in such a way that upon activation the traffic density information is displayed in a chronological order. By way of example the control element may be a turn button and by turning, the traffic density may be displayed over time allowing the user to visualize existing traffic patterns. Other possible control elements include for example a lever or forwards/backwards buttons in either hard- or software, where sliding the lever or pressing the buttons allows to move back and forth along the time axis.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of a system that displays historical traffic density information in accordance with an example implementation;

FIG. 2 shows a depiction of a display displaying the traffic density information in accordance with an example implementation;

FIG. 3 shows a diagram of a flowchart comprising the steps for displaying the traffic density information of FIG. 2; and

FIG. 4 shows diagram of a flowchart for another example implementation for displaying traffic density information.

### DETAILED DESCRIPTION

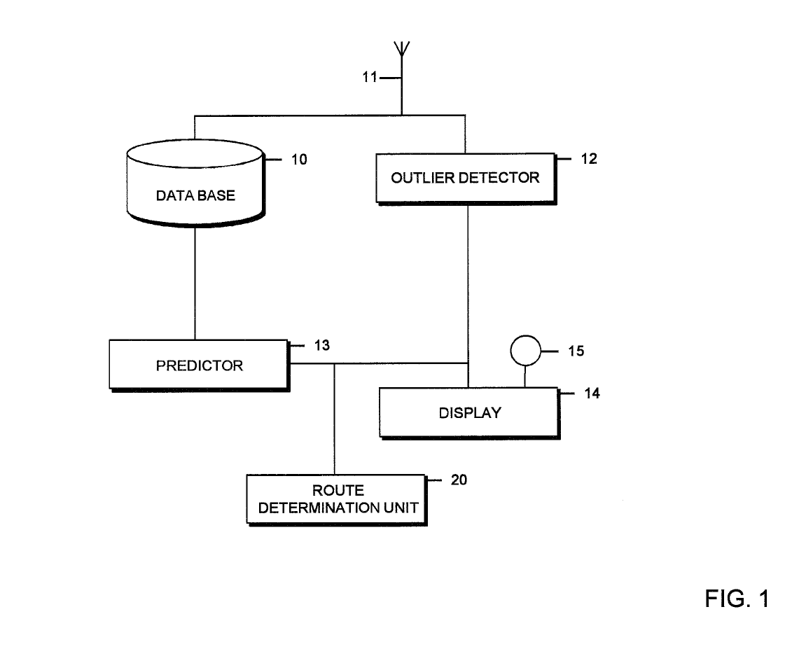

In FIG. 1, a system is shown with which traffic density information, be it historical traffic density information or future traffic density, may be displayed. The system comprises an optional database 10, the database 10 may have historical traffic density information. By way of example, the historical traffic density information may be a collection of traffic messages from the TMC signal component. The database may be updated when new traffic messages are received via an antenna 11. In case new traffic messages are received, the traffic information may be fed to a predictor 13, where the newly received data may be used in the prediction module and to update the predictor. The traffic density information contained in database 10 may correspond to traffic patterns depending on time. The data in the database 10 may be used to support the predictor 13 or to re-train the predictor 13.

When new traffic messages are received, it is determined how the data influence the existing traffic patterns. The system of FIG. 1 filters out outliers and learns from the received traffic messages by adapting the predictor. The detection of outliers may be done in an outlier detector 12. If necessary, the data is also stored in the database 10. Furthermore, the predictor 13 determines the traffic density for a predetermined moment in time. This moment in time needs not necessarily be in the future. By way of example, a user of the system shown in FIG. 1 may want to have additional information about the traffic situation as it normally occurs over the day. The user might be interested to be informed of the traffic situation for a certain route depending on the day or depending on the time of the day. The predictor may either predict the requested traffic density information by itself, or it can select a most probable situation from the database 10 and displays it on a display 14. For predicting the future traffic density, the predictor 13 may use a classification process, a statistical regression analysis, a graphical model or a statistical model based e.g. on a Markov chain. The predictor 13 may also use a combination of the different prediction methods in order to improve the prediction accuracy.

The system of FIG. 1, furthermore may have a control element 15 with which the displaying of the traffic density information may be controlled depending on time. By way of example the control element 15 may be a turn button and by turning the turn button 15 a display 14 may display traffic information depending on time for the part of the route the user is interested in. By way of example by turning the button 15 to the right, the traffic density information may be displayed over time in a chronological order; by turning to the left the chronological order may be reversed.

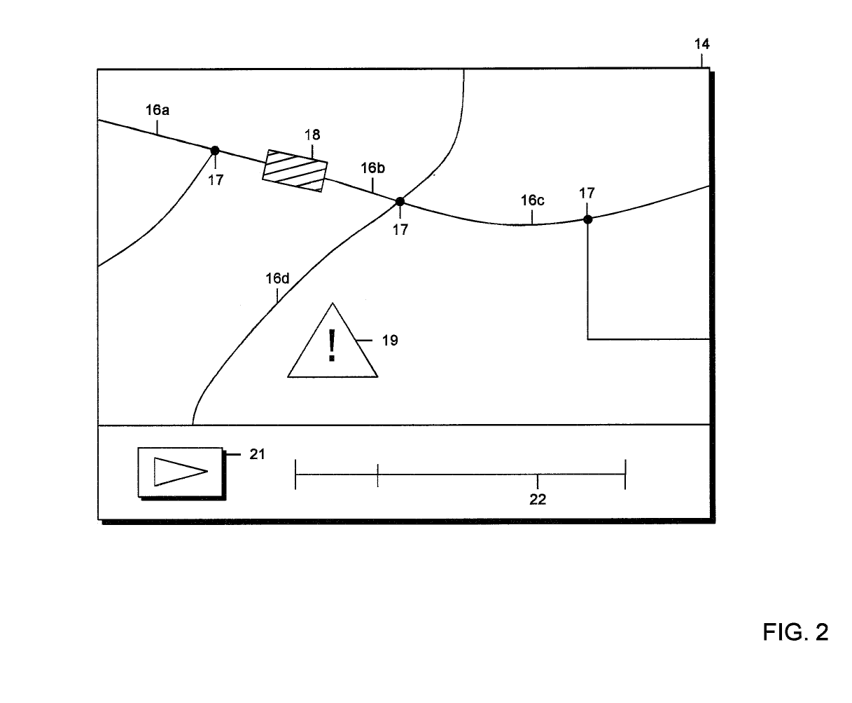

In FIG. 2, an exemplary view of traffic density information as it may be shown on a display is depicted. The display 14 may show a road network with different road segments 16a, 16b, 16c, and 16d separated by vertices 17. The traffic density information may be indicated by showing the different road segments in different colors, the color depending on the traffic density. In the implementation depicted in FIG. 2, the traffic density information may provide the information that on the road segment 16b normally a traffic congestion is present for a displayed moment in time, the displayed road segment having another color or being highlighted otherwise as represented by the bar 18. Another way to highlight a difficult traffic situation is to use traffic signs as traffic sign 19 indicating a difficult traffic situation normally occurring at road segment 16d. It should be understood that the display shown in FIG. 2 does not display traffic messages as they are currently received, but displays an aggregated traffic pattern combined on the basis of a plurality of traffic densities.

The database or the trained predictors may contain the traffic situation for different periods of time during the day. By way of example the database 10 may contain the traffic density information for the moment in time “t”. The predictor 13 may then be configured in such a way so as to predict the traffic density at the time t+Δt. With the predictor 13 it is possible to calculate traffic density information over time, e.g. the entire day, when a traffic situation is known for certain moments in time during said day. The prediction can be obtained using a Markov chain in which the vertices correspond to the states and in which the road segments or edges correspond to the transitions. A Markov chain may be based on the road map corresponding to the states which is a set of vertices of a graph and the transition steps involve moving to the neighboring vertices. However, it is understood that any other known ways of predicting the traffic density information provided on the historical traffic density data could be used.

The predictor may furthermore predict a future traffic density using the historical existing traffic density information in the database 10. A route calculation unit 20 may use the traffic density information and calculate a route to a predetermined destination taking into account predicted future traffic density information and/or historical traffic density information.

As explained above, the control element 15 may be provided allowing control of the display 14, i.e. allowing the temporal evolution of the traffic density to be displayed. Additionally, as shown in FIG. 2, it is possible to control the display via soft switches provided on the display. By way of example a start button 21 may be displayed and a time range 22. By pressing the start button, e.g. on a touch screen, the traffic density evolution may be shown as a movie or animation. Additionally, the user has the possibility to select a certain moment in time on the time range 22.

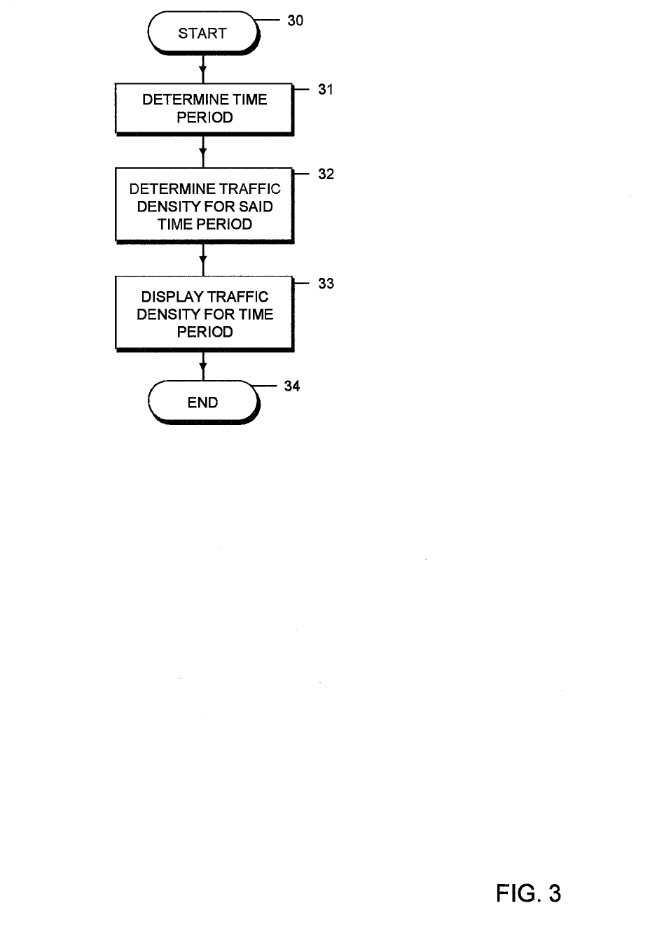

In FIG. 3, a diagram of a flowchart is shown allowing a user to better plan a trip to a predetermined destination. The procedure starts in step 30. In step 31 the user determines for which period of time or for which moment in time the traffic density information should be extracted or identified. When the desired time has been selected in step 31, it is possible in step 32 to determine the traffic density for said period in time or for the selected moment in time by optionally accessing database 10. The predictor 13 may then predict the traffic density for the selected period of time or moment in time, and the traffic density information can be displayed on the display 14 in step 33. In case the desired time was a period of time, the display 14 may display the traffic density in a chronological order, whereas in case the desired time was a moment in time the display may display an image of the traffic density. With the information provided the user may better plan the trip to the desired destination, as the user is informed about the positions and the time of traffic congestions that usually occur on the desired route. The method ends in step 34.

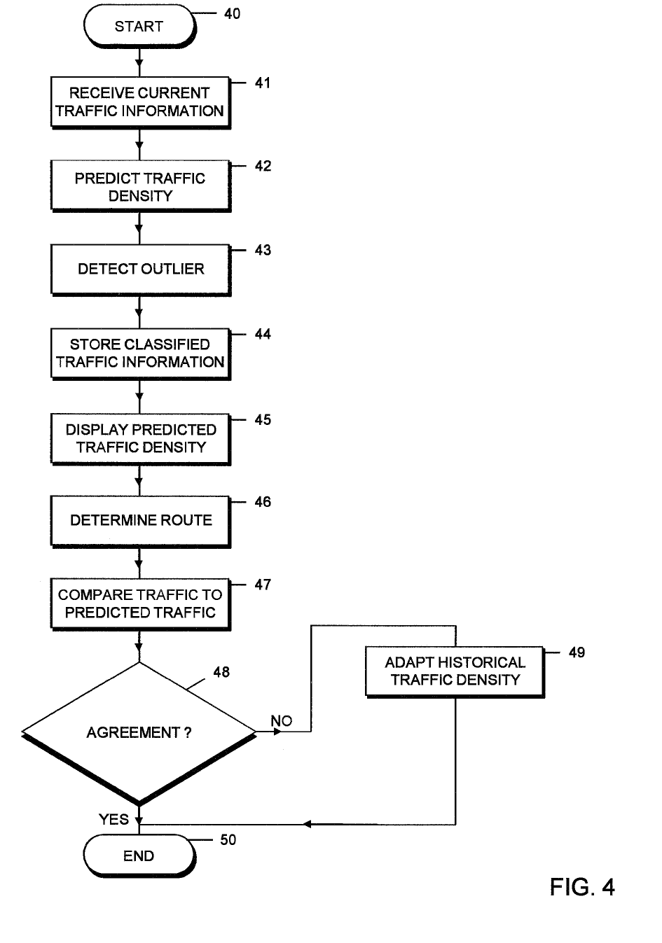

In FIG. 4, a diagram of another flowchart showing another example implementation is depicted. The method starts in step 40 and in step 41 the current traffic situation is received via antenna 11. The predictor 13 shown in FIG. 1 may calculate an expected traffic situation and a confidence level indicating the probability of a calculated traffic density (step 42). In the case of new traffic data being received, the new traffic data may influence the confidence level of the traffic densities as displayed or may influence the traffic density contained in the predictor 13 or contained in the optional database 10 and additional processing may result. By way of example, if the same traffic information is received several times it may be necessary to adapt the traffic density information provided for the road segment for which the traffic information is received. In step 43, after the prediction process, it is determined whether the current traffic information is an outlier with the outlier detector 12, meaning that it is determined whether or how the current traffic information influences the historical traffic density information contained in the predictor 13 or the optional database 10. In case the received traffic information is not an outlier, it is either used to train the predictor 13 or stored in the optional database in step 44.

Now it might happen that the user would like to be informed of the future traffic density, e.g. within the next two hours. The predictor 13 may then predict the traffic density and the predicted traffic density may be displayed on display 14 in step 45. The route calculation unit may additionally calculate a route to the desired destination taking into account the predicted traffic density in step 46. During traveling, in case the vehicle continuously receives traffic information, the system may compare the predicted traffic density to the current traffic density in step 47. If the traffic density is in agreement with the current traffic density as determined in step 48, the process ends in step 50. However, if the predicted traffic density differs from the actual traffic density by a certain amount, it may be necessary to adapt the historical traffic density in step 49 by either adapting the confidence levels or by adapting the historical traffic density data themselves or by adapting both.

As can be seen from the above description, a user is able to visualize historical traffic density information and use the information to help improve the route selection and calculation, as the user of the system is better informed of typically occurring traffic congestions and as it is possible to predict future traffic densities and confidence levels based on the knowledge of the historical traffic densities.

It will be understood, and is appreciated by persons skilled in the art, that one or more processes, sub-processes, or process steps described in connection with FIGS. 1-4 may be performed by hardware and/or software. If the process is performed by software, the software may reside in software memory (not shown) in a suitable electronic processing component or system such as, one or more of the functional components or modules schematically depicted in FIGS. 1-4. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any tangible computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, or store the program for use by or in connection with the instruction execution system, apparatus, or device. The computer readable medium may selectively be, for example, but is not limited to, an electronic, magnetic, optical, electromagnetic, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program may be stored and read, such as punch cards.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method for displaying traffic density information, comprising the following steps:
providing historical traffic density information;
determining for which moment in time the traffic density information should be displayed;
determining the traffic density information for said moment in time with a predictor; and
displaying the traffic density information for said moment on a display.

2. The method of claim 1, where the traffic density information is displayed in different colors in dependence on the traffic density.

3. The method of claim 1, further comprising the step of predicting a traffic density based on the historical traffic density information.

4. The method of claim 1, further comprising the step of collecting current density information, outlier detection of the current traffic density information with an outlier detector.

5. The method of claim 4, where the outlier detection step comprises the step of comparing the current traffic information to the already existing historical traffic density information and determining whether the historical traffic density information is adapted in view of the current traffic density information.

6. The method of any of claims 3 to 5, further comprising the step of predicting a future traffic density and of comparing the predicted future traffic density at a predetermined moment in time to the actual traffic density at said moment in time, where the prediction of the traffic density is adapted based on the comparison.

7. The method of any of the preceding claims, where the historical traffic density information is determined by collecting traffic information contained in a radio signal.

8. The method of any of the preceding claims, where the historical traffic density information is used for determining a route to a predetermined destination.

9. The method of claim 8, where a confidence level is calculated for the predicted historical traffic density information, where for calculating a route to a predetermined destination the confidence level is taken into account.

10. The method of claim 1, further comprising the step of collecting traffic density information over time and displaying the traffic density information in chronological order to a user.

11. The method of claim 10, where the future traffic density is predicted using at least one of a classification process, statistical regression analysis, graphical model, and statistical model.

12. A system for displaying traffic density information, comprising:
a predictor containing historical traffic density information depending on time;
a traffic density determination unit determining the traffic density information for a predetermined moment in time; and
a display displaying the traffic density information for said moment in time.

13. The system of claim 12, where the traffic density determination unit comprises an outlier detector determining the outlier status of the collected historical traffic density information.

14. The system of claim 12, where the traffic density determination unit comprises a predictor predicting a future traffic density based on the historical traffic density information.

15. The system of claim 14, where the outlier detector receives current traffic density information, determines the outlier state of the information and transmits the processed traffic density information to the database.

16. The system of claim 14, where the outlier detector receives current traffic density information, determines the outlier state of the information and transmits the processed traffic density information to the predictor.

17. The system of any of claim 14, further comprising a route determination unit determining a route to a predetermined destination on the basis of the historical traffic density information and or on the basis of the predicted future traffic density.

18. The system of claim 17, where the predictor calculates a confidence level, the route determination unit determining a route to a predetermined destination taking into account the calculated confidence value.

19. The system of claim 18, further comprising a control element which, upon activation, displays the traffic density information in a chronological order.

20. The system of claim 12, wherein the display displaying the traffic density information displays the traffic density information in at least one color.

21. The system of claim 12, wherein the display displaying the traffic density information displays the traffic density information with at least one traffic sign.
